(19) United States
(12) Patent Application Publication
(10) Pub. No.: US 2014/0111574 A1
(43) Pub. Date: Apr. 24, 2014

(54) LIQUID EJECTING APPARATUS

(71) Applicant: Seiko Epson Corporation, Tokyo (JP)

(72) Inventor: Kinya OZAWA, Shiojiri-shi (JP)

(73) Assignee: Seiko Epson Corporation, Tokyo (JP)

(21) Appl. No.: 14/058,104

(22) Filed: Oct. 18, 2013

(30) Foreign Application Priority Data
Oct. 22, 2012 (JP) 2012-232579

(51) Int. Cl. B41J 2/165

(52) U.S. Cl. CPC B41J 2/16535
USPC 347/26

(57) ABSTRACT

A liquid ejecting apparatus includes a liquid ejecting head which is capable of ejecting a photo-curable liquid to be cured by irradiation with light from nozzles which open at a nozzle surface of a nozzle-forming member; a wiping unit for wiping the nozzle surface with a wiping member in contact with the nozzle surface, a portion of the wiping member in contact with the nozzle surface being made of cloth; and a heating mechanism for generating heat to heat the nozzle surface; wherein the wiping member is capable of wiping the nozzle surface in a state in which an ink splash of a photo-curable liquid attached on the nozzle surface has been softened by heating of the heating mechanism.

### BACKGROUND

1. Technical Field

The present invention relates to a liquid ejecting apparatus including a liquid ejecting head for ejecting a liquid from nozzles which open at a nozzle surface, and more particularly, relates to a liquid ejecting apparatus including a wiping unit for wiping a nozzle surface.

2. Related Art

A liquid ejecting apparatus is an apparatus including a liquid ejecting head from which various liquids are ejected. The liquid ejecting apparatus may be, for example, an image recording apparatus such as an ink jet printer and an ink jet plotter, and recently, it has been applied to various manufacturing systems by taking advantage of the ability to accurately eject a very small amount of liquid to a desired position on various media. For example, it has been applied to a display manufacturing system for manufacturing a color filter of a liquid crystal display or the like, an electrode forming system for forming electrodes of an organic electroluminescence (EL) display, field emission display (FED), that is plane emission type display, or the like, and a chip fabrication system for fabricating a biochip (biochemical device).

The liquid ejecting head ejects liquid droplets from nozzles, which open at a nozzle surface, by operating piezoelectric elements (a kind of a pressure generator) to change the pressure of a liquid in a pressure chamber. In this case, ejecting (discharging) of ink droplets from the nozzles of the liquid ejecting head can cause fine spray (mist) of the ink to be scattered and then to be attached on the nozzle surface. Deposition of mist on the nozzle surface can lead to defective ink discharge. There is a known liquid ejecting apparatus including a wiping mechanism for periodically wiping the nozzle surface (for example, as described in JP-A-8-142345). In addition, a liquid ejected from a liquid ejecting head may be a UV ink (a photo-curable ink) to be cured by irradiation with ultraviolet (UV) rays (for example, as described in JP-A-2012-171236).

The UV ink as described above is known to have a viscosity higher than that of a common ink (for example, an aqueous ink). Therefore, when the mist of the UV ink becomes attached to the nozzle surface, an existing wiping mechanism is incapable of sufficiently wiping the mist. In addition, increasing the force for wiping the mist increases a shear force applied between the nozzle surface and the mist, whereby the nozzle surface can be damaged (for example, a water repellent film applied on the nozzle surface is peeled off). In particular, the shape of the UV ink droplets with high viscosity ejected from the nozzle stretches during flight and easily breaks up, thereby easily forming into a mist. In addition, because the UV ink is cured by irradiation with light, it is necessary to wipe mist attached on the nozzle surface as soon as possible. As a result, the number of times the nozzle surface is wiped increases, and as a result, the nozzle surface can be damaged more easily.

### SUMMARY

An advantage of some aspects of the invention is that it provides a liquid ejecting apparatus which is capable of sufficiently wiping a nozzle surface of a liquid ejecting head as well as suppressing damage to the nozzle surface, even if the liquid ejecting apparatus includes a liquid ejecting head for ejecting a photo-curable liquid.

According to an aspect of the invention, there is provided a liquid ejecting apparatus, including a liquid ejecting head, a wiping unit, and a heating mechanism. The liquid ejecting head is capable of ejecting a photo-curable liquid to be cured by irradiation with light from nozzles which open at a nozzle surface of a nozzle-forming member. The wiping unit wipes the nozzle surface with a wiping member in contact with the nozzle surface, the portion of the wiping member in contact with the nozzle surface being made of cloth. The heating mechanism generates heat to heat the nozzle surface. The wiping member is capable of wiping the nozzle surface in a state in which the nozzle surface is being heated by the heating mechanism.

According to the configuration, the wiping member is capable of wiping the nozzle surface in a state in which the heating mechanism is heating and softening the photo-curable liquid attached on the nozzle surface so that the photo-curable liquid attached on the nozzle surface may be easily wiped off. Moreover, heating the nozzle surface by the heating mechanism includes not only direct heating but also indirect heating of the nozzle surface. Thus, the shear force between the nozzle surface and the ink splash may be limited, thereby suppressing the damage to the nozzle surface when wiping the ink splash. As a result, defective discharge may be inhibited. In addition, because the nozzle surface is wiped with a contact portion, made of cloth, in contact with the nozzle surface, the ink splash of a photo-curable liquid may be absorbed between fibers constituting the cloth and the ink splash may be more easily wiped off the nozzle surface.

In the above-described configuration, the heating mechanism is provided in the wiping unit, and the heating mechanism is capable of heating the wiping member.

According to the configuration, the ink splash of the photo-curable liquid attached on the nozzle surface may be heated in this simple configuration.

In the above-described configuration, the wiping unit includes an impregnation liquid reserving section for storing an impregnation liquid with which the wiping member is impregnated. The heating mechanism is provided in the impregnation liquid reservoir. The heating mechanism is capable of heating the impregnation liquid.

According to the configuration, the heated impregnation liquid may heat the ink splash of the photo-curable liquid attached to the nozzle surface. In addition, the impregnation liquid acts as a lubricant, thereby suppressing damage to the nozzle surface due to rubbing of the surface with the wiping member. In addition, the impregnation liquid may humidify a photo-curable liquid attached on the nozzle surface to decrease the viscosity, whereby the ink splash may be wiped off the nozzle surface.

In addition, the heating mechanism is provided in the liquid ejecting head. The heating mechanism is capable of heating the nozzle-forming member.

According to the configuration, heating of the nozzle-forming member may heat the ink splash of the photo-curable liquid attached on the nozzle surface. In addition, when the photo-curable liquid is being ejected from the nozzle, the liquid may be heated. Thus, an increase in the viscosity of the photo-curable liquid may be inhibited. As a result, photo-curable liquid may be consistently ejected.

In the above-described various configuration, the nozzle surface has a concave region including a region having the nozzles formed thereon and a convex region protruding toward the wiping unit from the concave region. The wiping member is capable of being brought into contact with the concave region and the convex region, and has a region opposing the concave region recessed away from the nozzle surface with respect to a region opposing the convex region.

According to the configuration, when the wiping member is brought into contact with the nozzle surface, the pressure applied on the concave region may be limited. Thus, damage to the concave region of the nozzle surface, i.e., damage to the region having the nozzles formed thereon due to rubbing of the region with the wiping member may be suppressed. As a result, defective discharge may be inhibited.

### BRIEF DESCRIPTION OF THE DRAWINGS

The invention will be described with reference to the accompanying drawings, wherein like numbers reference like elements.

FIG. 1A and FIG. 1B are a schematic sectional view and a schematic plan view, respectively, illustrating a configuration of a printer.

FIG. 2A is a sectional view of a recording head and FIG. 2B is an enlarged view of a region IIB.

FIG. 3 is a schematic view illustrating a wiper unit including a heater.

FIG. 4 is a schematic view illustrating a wiper unit including a heater according to another embodiment.

FIGS. 5A and 5B are schematic sectional views illustrating a wiper unit according to another embodiment in which a contact surface of a cloth wiper on the side of the recording head is flat and corrugated, respectively.

FIGS. 6A and 6B are schematic sectional views illustrating the recording head including a heater on the side of the fixing plate and the channel substrate, respectively.

### DESCRIPTION OF EXEMPLARY EMBODIMENTS

Embodiments of the invention will now be described with reference to the accompanying drawings. Moreover, although preferred concrete examples of the invention are described in the following embodiments, the scope of the invention is not intended to be limited to the aspects unless otherwise specified as limiting the invention in the following description. In addition, the following description includes an ink jet printer (hereinafter referred to as a printer) having an ink jet recording head, i.e., a kind of liquid ejecting head (hereinafter referred to as a recording head) as a liquid ejecting apparatus of an aspect of the invention.

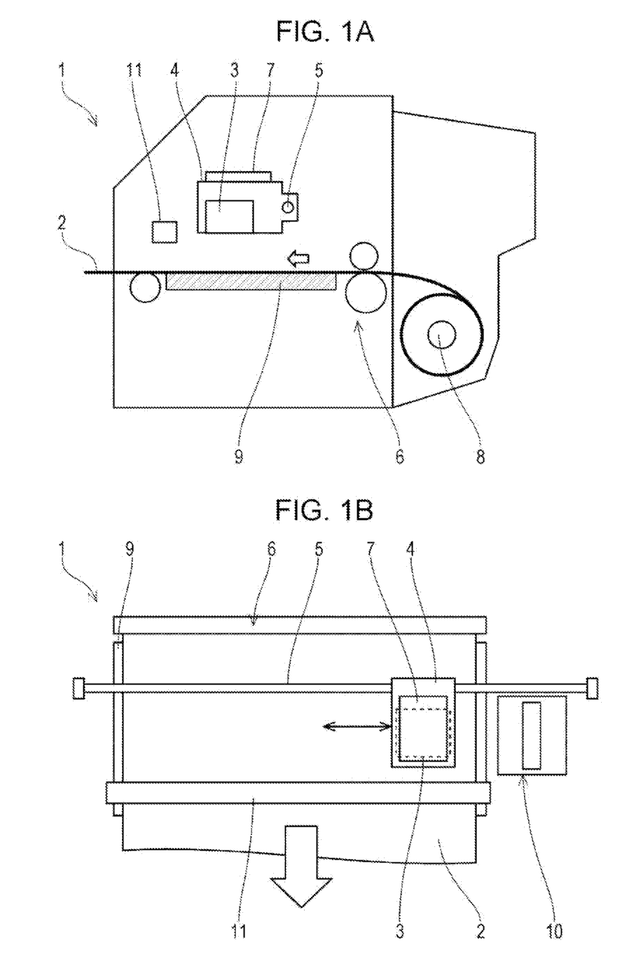

A configuration of a printer 1 will be described with reference to FIGS. 1A and 1B. The printer 1 is an apparatus for recording an image or the like by ejecting a liquid ink to the surface of a recording media 2 (a kind of deposition target) such as a recording paper. The printer 1 includes a recording head 3, a carriage 4 for carrying the recording head 3, a guide rod 5 for axially guiding the carriage 4, and a transport mechanism 6 for transferring a recording media 2 in a sub-scanning direction (in the direction of an arrow in FIG. 1A). The recording media 2 in this embodiment is held in roll that is wound around the core 8. Then, the recording media 2 moves on the platen 9, spaced apart from the lower surface of the recording head 3 (the nozzle surface 50), by operation of the transport mechanism 6. Moreover, a configuration may be employed in which a plurality of recording media are accommodated in a paper feed tray disposed below the platen 9 and a transport mechanism 6 transports the recording media one by one.

In this embodiment, the UV ink (a kind of a photo-curable liquid in the invention) to be cured by irradiation with ultraviolet rays is used. The UV ink contains a photopolymerization initiator and has a viscosity higher than that of a common ink (for example, an aqueous ink). In addition, the viscosity of the UV ink changes considerably with temperature compared with a common ink. That is, the UV ink significantly decreases its viscosity with increasing temperature compared with a common ink. The UV ink is stored in the ink cartridge 7 as a liquid source. Then, the ink cartridge 7 is removably mounted on the carriage 4 (the recording head 3). In addition, above the platen 9 and downstream of the recording head 3 in the sub-scanning direction, the UV lamp 11 (a kind of light source) is located across the recording region so as to irradiate the recording media 2 with ultraviolet rays. The ultraviolet rays from the UV lamp 11 reach the UV ink on the recording media 2 and cure (solidify) the UV ink. Thus, after the UV ink ejected from the recording head 3 deposits on the recording media 2, the transport mechanism 6 transfers the recording media 2 to the UV lamp 11 and the UV ink on the recording media 2 is cured and fixed on the recording media 2. Moreover, a configuration may be employed in which the ink cartridge 7 is located on the side of the body of the printer 1 and the ink is supplied from the ink cartridge 7 through an ink supplying tube to the recording head 3.

The above-described guide rod 5 is constructed within the printer 1 so as to be oriented in a direction perpendicular to the sub-scanning direction. The carriage 4 is made to reciprocate by a pulse motor (not shown) such as a DC MOTOR in a main scanning direction (in a direction of the width of the recording media 2) while being guided by the guide rod 5. In the end region out of the recording region within the movement range of the carriage 4 (in the region outside the platen 9 in the main scanning direction), the home position, i.e., the starting point of scanning of the carriage 4 is established. In the home position, the wiping unit 10 (described hereinafter) for wiping the nozzle surface 50 of the recording head 3 is provided. Then, the printer 1 performs so-called bidirectional recording of characters, images, or the like on a recording paper 5. In the bidirectional recording, recording is performed in both forward moving of the carriage 4 from the home position to the opposite end and backward moving of the carriage 4 from the opposite end to the home position.

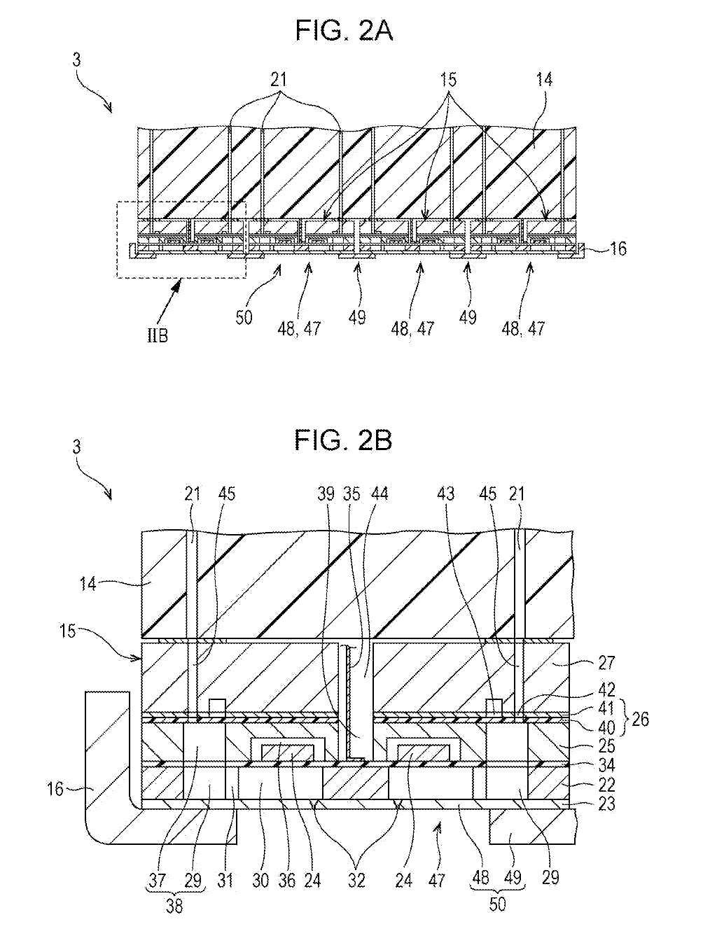

The recording head 3 will now be described with reference to FIGS. 2A and 2B. FIG. 2A is a sectional view of the recording head 3 and FIG. 2B is an enlarged view of a region IIB in FIG. 2A. The recording head 3 according to the embodiment is constituted by a holder 14, a recording head body 15 (a kind of liquid ejecting head body), and the fixing plate 16. In addition, four recording head bodies 15 are spaced apart from each other in the recording head 3.

The holder 14 is a retaining member including a cartridge mounting section (not shown), made of a resin or the like, for mounting the ink cartridges 7 in the upper portion of the cartridge mounting section. A head casing 27 (described hereinafter) of the recording head body 15 is connected to the lower portion of the holder 14. In addition, a liquid introducing channel 21 is provided within the holder 14, in which one end opens at the cartridge mounting section and the other end opens at the lower surface (at the side of the recording head body 15). The UV ink from the ink cartridge 7 is introduced through the liquid introducing channel 21 to the recording head body 15. Moreover, the holder 14 and the recording head body 15 are coupled to each other via an adhesive or the like.

The recording head body 15 includes, as shown in FIG. 2B, a channel substrate 22, a nozzle plate 23 (corresponding to a nozzle-forming member in the invention), a piezoelectric element 24 (a kind of pressure generator), a protective substrate 25, a compliance substrate 26, and the head casing 27.

The channel substrate 22 is composed of a silicon monocrystal substrate which is longer along the nozzle array direction (the sub-scanning direction in this embodiment), and two elongated communicating sections 29 are formed in the channel substrate 22 in the same direction. In the region between the communicating sections 29, a plurality of pressure chambers 30 are arranged in two rows juxtaposed to each other in the nozzle array direction. Each of the pressure chambers 30 communicates with a corresponding one of the communicating sections 29 via a liquid supply passageway 31 which is narrower than the pressure chamber 30.

The nozzle plate 23 is secured via an adhesive or a heat-welding film or the like to the lower surface of the channel substrate 22 (to the surface on the side opposite the piezoelectric element 24). The nozzle plate 23 is formed of stainless steel (SUS) or single-crystal silicon or the like, and a plurality of nozzles 32 are formed by drilling. Each of the nozzles 32 communicates with the pressure chamber 30 at a position away from the liquid supply passageway 31 of each of the pressure chambers 30. The nozzle array arranged in a row of, for example, 360 dpi pitch is constituted by the nozzles 32. Moreover, an ink repellent film is formed on the lower surface (the nozzle surface 50) of the nozzle plate 23. Thus, the film may inhibit the UV ink attached on the nozzle surface 50 from expanding.

The upper surface of the channel substrate 22 (on the opposite side to the nozzle plate 23) is laminated with an elastic film 34. On the elastic film 34, the piezoelectric elements 24 (a kind of pressure generator) are arranged in two rows juxtaposed to each other and opposing each of the pressure chambers 30. A lower electrode film, a piezoelectric body layer, and an upper electrode film are sequentially stacked to form the piezoelectric elements 24. One end of the piezoelectric element 24 (center side) is connected to one end of a lead electrode (not shown), which is connected to the upper electrode film. Another end of the lead electrode extends toward the center of the head body on the insulating film, and is electrically connected to one end of a flexible cable 35. Moreover, another end of the flexible cable 35 is connected to a control section (not shown).

In addition, the protective substrate 25 having a piezoelectric element retention space 36 which is large enough so as not to block the displacement of the piezoelectric element 24 in the region opposing the pressure chamber 30 is coupled onto the elastic film 34. At a position opposing the communicating section 29 of the protective substrate 25, a long hollow liquid chamber 37 is arranged so as to penetrate the protective substrate 25 in the thickness direction. In addition, in the central portion of the protective substrate 25, a configuration space 39 is arranged so as to allow connection of the flexible cable 35 and the lead electrode. Moreover, the hollow liquid chamber 37 communicates with the communicating section 29 so as to form a reservoir 38 (a common liquid chamber) for supplying the ink to the pressure chamber 30.

The compliance substrate 26 is a substrate in which a flexible sealing film 40 and a fixed substrate 41 composed of a hard member such as metal are stacked, and coupled to the upper side of the protective substrate 25 (on the side opposite the channel substrate 22). In the compliance substrate 26, a liquid introducing port 42 for introducing the ink into the reservoir 38 is formed so as to penetrate the substrate 26 in the thickness direction. In addition, in a region of the compliance substrate 26 opposing the reservoir 38 except the liquid introducing port 42, the sealing section 43 is constituted only by the sealing film 40 with the fixed substrate 41 removed. Therefore, the reservoir 38 is sealed by the flexible sealing section 43, thereby obtaining compliance.

The head casing 27 is a hollow box member coupled to the upper portion of the compliance substrate 26 (opposite side to the protective substrate 25). An insertion space 44 communicating with the configuration space 39 of the protective substrate 25 and a casing channel 45 communicating with the liquid introducing channel 21 are formed within the head casing 27 so as to penetrate the head casing 27 in the height direction. The flexible cable 35 is inserted within the insertion space 44. The casing channel 45 is a channel for supplying the ink into the reservoir 38 from the holder 14. The casing channel 45 communicates with the liquid introducing channel 21 at its top end and communicates with the liquid introducing port 42 at its bottom end. Moreover, in a certain portion of the lower surface of the head casing 27, a sealed space serving as the sealing section 43 is formed so as to accommodate the flexible deformation of the sealing film 40.

Then, the UV ink is brought from the ink cartridge 7 through the liquid introducing channel 21 and the casing channel 45 into the reservoir 38. The UV ink that has been brought into the reservoir 38 is supplied through the liquid supply passageway 31 into the pressure chamber 30. In this state, operation of the piezoelectric element 24 results in a change in the pressure of the UV ink within the pressure chamber 30. The UV ink is ejected from the nozzles 32 due to the pressure change.

The fixing plate 16 is a plate member made of stainless steel (SUS) or the like, coupled to the nozzle plate 23 of the recording head body 15. The fixing plate 16 in this embodiment, as shown in FIGS. 2A and 2B, is coupled entirely to four recording head bodies 15 and, at its periphery, is bent toward the recording head body 15 in the outer side of the recording head 3 (the recording head body 15). In addition, the fixing plate 16 has opening regions 47 so as to expose the nozzles 32 of each of the recording head bodies 15. Four opening regions 47 corresponding to four recording head bodies 15 in this embodiment are juxtaposed in a direction perpendicular to the nozzle array direction. The opening region 47 is a rectangular opening penetrating the fixing plate 16 in the thickness direction, and is at least as large as the size such that all the nozzles 32 of the recording head body 15 may be exposed. Moreover, a region of the lower surface of the nozzle plate 23 of each of the recording head bodies 15 facing the opening region 47 corresponds to the concave region 48 of an aspect of the invention, and a region of the lower surface of the fixing plate 16 except the opening region 47 corresponds to the convex region 49 of an aspect of the invention. Then, the concave region 48 and the convex region 49 correspond to the nozzle surface 50 of an aspect of the invention. That is to say, the concave region 48 including a region having the nozzles 32 formed thereon and the convex region 49 protruding downward with respect to the concave region 48 (on the side of the wiping unit 10 or on the side of the platen 9) correspond to the nozzle surface 50.

The wiping unit 10 will now be described. The wiping unit 10 according to the embodiment, as shown in FIG. 3, includes a cloth wiper 51 (corresponding to the wiping member of an aspect of the invention) including a contact portion (the contact surface), made of cloth 54, which is brought into contact with the nozzle surface 50, an impregnation liquid reserving section 52 for storing an impregnation liquid with which the cloth wiper 51 is impregnated, and a heater 53 (corresponding to the heating mechanism of an aspect of the invention) for generating heat to heat the impregnation liquid. The cloth wiper 51 includes the cloth 54 made of fibers of cotton, silk, glass, metal or the like, and a cylindrical roller 55 having the cloth 54 fixed thereto at the circumference thereof. In addition, the axial direction of the roller 55 in this embodiment is the same as the nozzle array direction. Furthermore, the length of the cloth wiper 51 in the nozzle array direction is set so as to be larger than the length of the nozzle surface 50 of the recording head 3 in the same direction. Moreover, the roller 55 is established so as to be rotatable by a driving source (not shown). In addition, a movement mechanism (not shown) for moving the wiping unit 10 upward and downward is arranged below the wiping unit 10 and is configured so as to be able to bring the cloth wiper 51 into contact with the nozzle surface 50 of the recording head 3 located at the home position.

The impregnation liquid reserving section 52 for containing a portion of the cloth wiper 51 is positioned below the cloth wiper 51 (on the opposite side of the recording head 3). The impregnation liquid reserving section 52 is formed into a box which opens at its top and is filled halfway with the impregnation liquid. Then, the cloth wiper 51 is positioned so that an upper portion of the cloth wiper 51 is exposed from the top open side of the impregnation liquid reserving section 52 and a lower portion is soaked in the impregnation liquid. Thus, the impregnation liquid may be permeated into the cloth 54 of the cloth wiper 51. Moreover, the impregnation liquid is permeated into the whole cloth 54 by capillary attraction but the impregnation liquid may be impregnated into the whole cloth 54 by rotation of the cloth wiper 51 (the roller 55). In addition, the impregnation liquid may be any liquid that excludes a photopolymerization initiator used for a UV ink (a compound used for curing a UV ink, which generates a radical by irradiation with light) but may be desirably a liquid that may easily decrease the viscosity of the UV ink (facilitate softening) or a liquid that may facilitate dissolution of the cured UV ink. Then, in the lower portion within the impregnation liquid reserving section 52, the heater 53 is arranged so as to be soaked in the impregnation liquid. The heater 53 may heat the impregnation liquid within the impregnation liquid reserving section 52. Then, the entire cloth 54 of the cloth wiper 51 is impregnated with the heated impregnation liquid, whereby the cloth wiper 51 may be heated.

The wiping operation performed by the wiping unit 10 will now be described. Generally, an ink becomes a form of mist when ejected from the nozzles 32, and a portion of the mist attaches to the nozzle surface 50. Because the mist deposited on the nozzle surface 50 can lead to defective ink discharge, the mist of the ink splash needs to be removed from the nozzle surface 50. In this case, because UV ink has, as described above, a high viscosity, the ink ejected from the nozzles 32 stretches during flight and easily breaks up, thereby easily forming into a mist. In addition, because the UV ink is cured by irradiation with light, it is necessary to wipe off mist of the ink splash attached on the nozzle surface 50 as soon as possible. Therefore, the wiping operation is performed periodically to wipe the nozzle surface 50. The wiping operation in this embodiment is performed, for example, after the UV ink has been ejected from the nozzles 32 more than a certain number of times.

First, before the wiping operation is performed, the heater 53 pre-heats the impregnation liquid. Then, the roller 55 is rotated so that the entire cloth 54 is impregnated with the heated impregnation liquid. Thus, the cloth wiper 51 becomes heated. Then, when the carriage 4 moves to the home position and the wiping unit 10 moves upward, the cloth wiper 51 is brought into contact with the nozzle surface 50 of the recording head 3. When the heated cloth wiper 51 is brought into contact with the nozzle surface 50, the nozzle surface 50 is heated and the mist of the UV ink splash attached on the nozzle surface 50 is softened. In this state, the carriage 4 (the recording head 3) is moved in the main scanning direction while rotating the cloth wiper 51 (the roller 55) so that the nozzle surface 50 is wiped. When the entire nozzle surface 50 has been wiped by the relative movement of the wiping unit 10 and the carriage 4, the rotation of the roller 55 is stopped and the wiping unit 10 is moved downward, thereby completing the wiping operation.

In this manner, the cloth wiper 51 may wipe the nozzle surface 50 in a state in which the heater 53 is heating the nozzle surface 50 (i.e., softening the mist of the UV ink attached on the nozzle surface 50) so that the mist of the ink splash (the UV ink) attached on the nozzle surface 50 may be easily wiped off. Thus, shear force applied between the nozzle surface 50 and the UV ink may be limited, allowing damage to the nozzle surface 50 to be suppressed when wiping off the mist of the ink splash. For example, the ink repellent film on the nozzle surface 50 may be inhibited from peeling off. As a result, defective discharge (ejecting) may be inhibited. In addition, because the nozzle surface 50 is wiped with the cloth wiper 51, whose surface is made of the cloth 54, in contact with the nozzle surface 50, the UV ink may be absorbed between fibers constituting the cloth 54 and the mist of the ink splash may be more easily wiped off the nozzle surface 50. In addition, because the impregnation liquid reserving section 52 includes the heater 53 which may heat the impregnation liquid, the heated impregnation liquid may heat the mist of the ink splash attached on the nozzle surface 50. Furthermore, the impregnation liquid acts as a lubricant, thereby suppressing damage to the nozzle surface 50 due to rubbing of the surface with the cloth wiper 51. Additionally, the impregnation liquid may humidify the mist of the ink splash attached on the nozzle surface 50 to decrease the viscosity (facilitate softening), whereby the mist of ink splash may be more easily wiped off the nozzle surface 50.

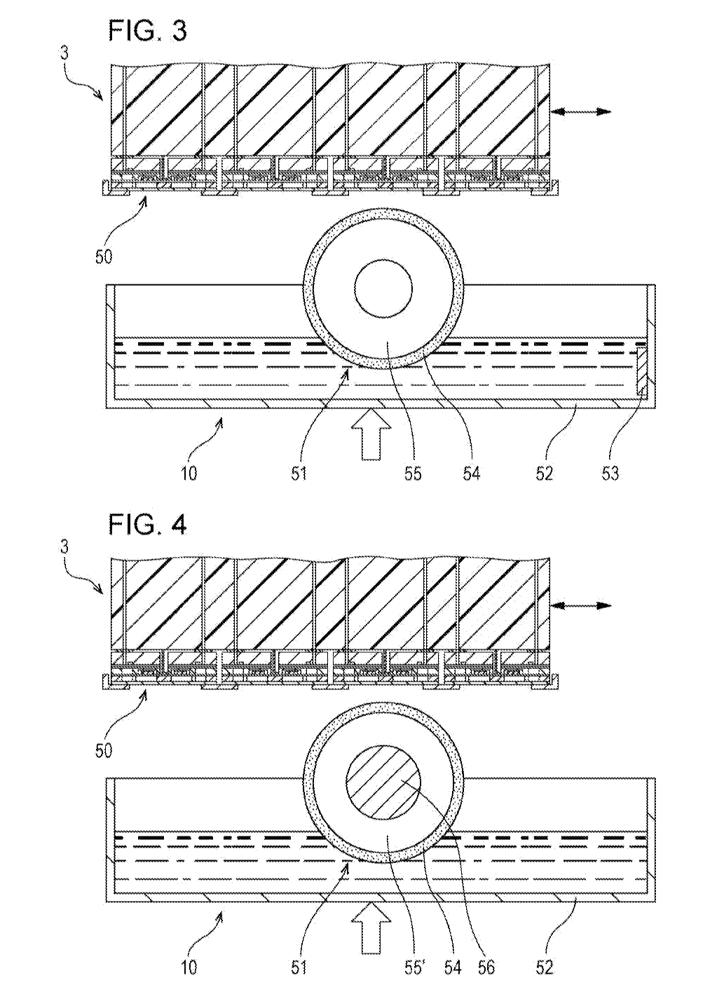

In the above-described embodiment, the heater 53 heats the impregnation liquid, which in turn heats the nozzle surface 50 (the mist attached on the nozzle surface 50), however the invention is not limited to the embodiment. For example, in a variation as shown in FIG. 4, a rod-like shaft heater 56 is provided in the center shaft of the roller 55′. According to this embodiment, the shaft heater 56 heats the cloth 54 of the cloth wiper 51 and the impregnation liquid, which in turn heats the nozzle surface 50. Moreover, a member between the shaft heater 56 and the cloth 54 constituting a body of the roller 55′ may be constituted by a metal having high thermal conductivity or the like or the shaft heater 56 may be directly wound around the cloth 54 without such a member. In addition, other configurations are the same as the above-described embodiment, so description thereof will be omitted.

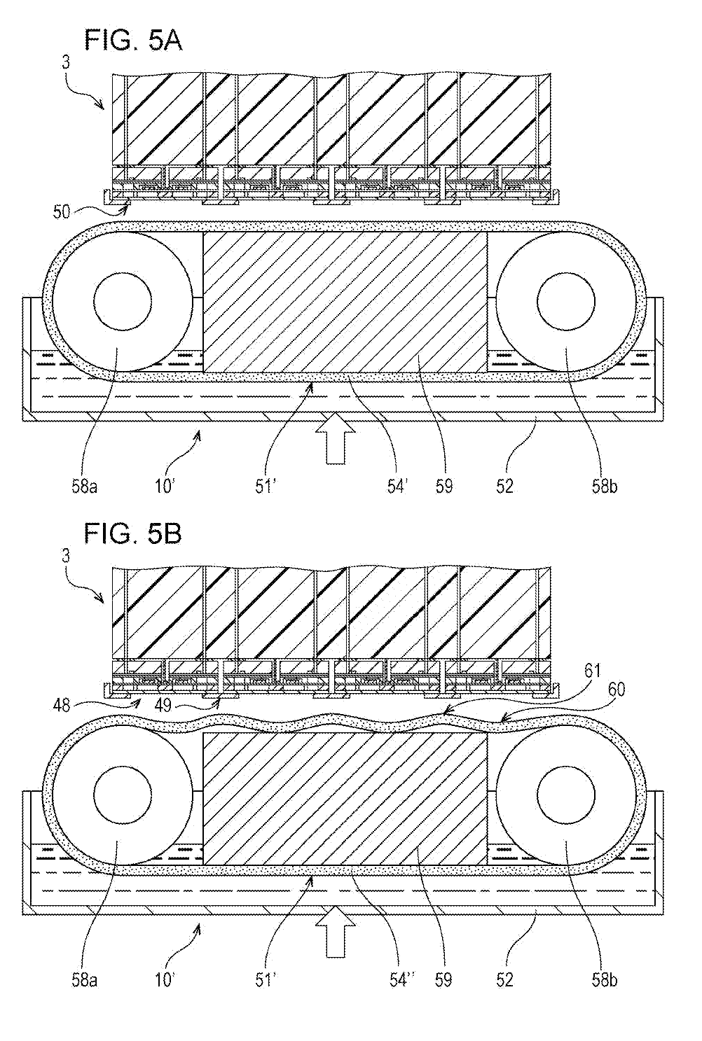

In addition, the cloth wiper 51 in the above-described embodiment is constituted by the cloth 54 wound around one roller 55 but the invention is not limited to this configuration. According to another embodiment shown in FIG. 5A, the cloth wiper 51′ is constituted by the cloth 54′ stretched to run round two rollers 58a and 58b. In detail, the length of both the rollers 58a and 58b in the nozzle array direction (the sub-scanning direction) is set so as to be larger than the length of the nozzle surface 50 of the recording head 3 in the same direction. In addition, the distance between the center shafts of both the rollers 58a and 58b is set so as to be larger than the length of the nozzle surface 50 of the recording head 3 in a direction perpendicular to the nozzle array (a main scanning direction). Then, the length of the cloth 54′ stretched around the rollers 58a and 58b in the nozzle array direction is set so as to be larger than the length of the nozzle surface 50 of the recording head 3 in the same direction. Therefore, an upper run of the stretched cloth 54′ (the surface in contact with the recording head 3) is larger than the nozzle surface 50 of the recording head 3. That is, if the cloth wiper 51′ is brought into contact with the nozzle surface 50 of the recording head 3, the entire nozzle surface 50 may be wiped without relative movement of the carriage 4 (the recording head 3) and the wiping unit 10′ in the main scanning direction. Moreover, one of the two rollers 58a and 58b is a driving roller having a driving source and another one is a rotatably axially supported driven roller.

Then, the heater 59 is positioned between the upper run and a lower run of the stretched cloth 54′ and between the two rollers 58a and 58b. The heater 59 in this embodiment is positioned in contact with or close to the upper run and the lower run of the cloth 54′, whereby the cloth 54′ may be heated from both an upper side and a lower side. Moreover, the heater 59 may be configured to heat one of the upper run and the lower run of the cloth 54′. In addition, the heater or the shaft heater for heating the impregnation liquid stored within the above-described impregnation liquid reserving section may be combined. Furthermore, other configurations are the same as the above-described embodiment, so description thereof will be omitted.

The wiping unit 10′ includes the rollers 58a and 58b rotating in a state in which the cloth wiper 51′ is in contact with the nozzle surface 50 of the recording head 3. As a result, the cloth 54′ wipes the entire nozzle surface 50. Therefore, the relative movement of the carriage 4 (the recording head 3) and the wiping unit 10′ is not necessary, whereby the wiping operation time period may be reduced. In addition, the heater 59 is positioned between two rollers 58a and 58b to heat the stretched cloth 54′, whereby a wide range of the cloth 54′ may be heated. Thus, heating efficiency is improved, so that the wiping operation time period may further be reduced.

Furthermore, in the cloth wiper 51′ in the above-described embodiment, the upper run of the cloth 54′ stretched around two rollers 58a and 58b (the surface in contact with the recording head 3) is flat, but the invention is not limited to this configuration. Regarding the cloth wiper 51′ of another embodiment shown in FIG. 5B, the upper run of the cloth 54″ stretched around two rollers 58a and 58b (the surface in contact with the recording head 3) is corrugated. In particular, a cloth concave region 60 of the upper run of the cloth 54″ opposing the concave region 48 of the nozzle surface 50 is recessed downward (away from the nozzle surface 50) from a cloth convex region 61 opposing the convex region 49 of the nozzle surface 50. For example, a pressing roller (not shown) or the like is positioned in a region outside the recording head 3 and on an extension of the cloth concave region 60 so as to press the portion of the cloth 54″ downward. In addition, the pressing roller (not shown) or the like is positioned in a region outside the recording head 3 and on an extension of the cloth convex region 61 so as to press the portion of the cloth 54″ upward. Thus, the cloth concave region 60 and the cloth convex region 61 are formed. In this embodiment, four concave regions 48 are formed in the nozzle surface 50, and correspondingly, four cloth concave regions 60 are formed on the upper run of the cloth 54″ of the cloth wiper 51′.

In this manner, because the cloth concave region 60 opposing the concave region 48 is recessed downward from the cloth convex region 61 opposing the convex region 49, the pressure applied on the concave region 48 may be limited when the cloth wiper 51′ is brought into contact with the nozzle surface 50. Thus, damage to the concave region 48 of the nozzle surface 50, i.e., the region having the nozzles 32 formed thereon due to rubbing of the surface with the cloth wiper 51′ may be suppressed. As a result, defective discharge may be suppressed. Moreover, other configurations are the same as the above-described embodiment, so description thereof will be omitted.

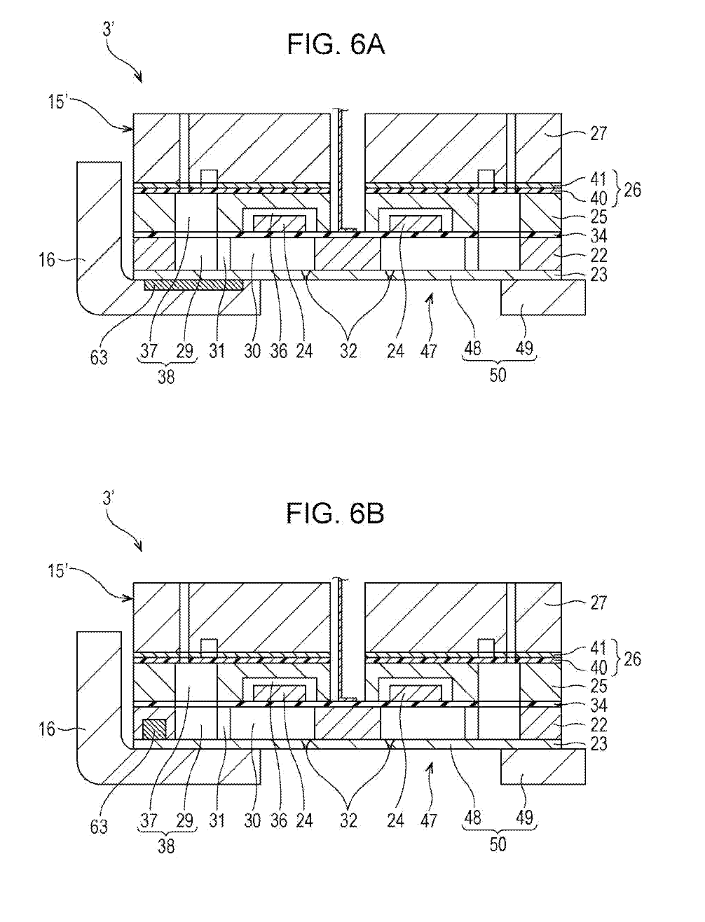

In the above-described embodiment, the heater is provided in the wiping unit 10, but the invention is not limited to this configuration. In another embodiment shown in FIGS. 6A and 6B, the heater is provided in the recording head 3′.

For example, in an embodiment shown in FIG. 6A, the heater 63 is provided between the fixing plate 16 of the recording head body 15′ and the nozzle plate 23. In particular, in a portion of the region of the fixing plate 16 that is coupled to the nozzle plate 23, a pit is formed recessed from the surface on the nozzle plate 23 halfway to the other side. The heater 63 for directly heating the nozzle plate 23 is positioned within the pit.

In addition, in an embodiment shown in FIG. 6B, the heater 63 is provided between the channel substrate 22 of the recording head body 15′ and the nozzle plate 23. In particular, in a portion of the region of the channel substrate 22 that is coupled to the nozzle plate 23 a pit is formed recessed from the surface on the nozzle plate 23 halfway to the other side, and the heater 63 for directly heating the nozzle plate 23 is positioned within the pit.

In this manner, because the heater 63 is provided so as to be in contact with the nozzle plate 23, direct heating of the nozzle plate 23 may heat the mist of the ink splash attached on the nozzle surface 50. In addition, when the UV ink is being ejected (discharged) from the nozzle, the UV ink may be heated. Thus, an increase in the viscosity of the UV ink may be inhibited. As a result, the UV ink may be consistently ejected. Moreover, the heater is not limited to these embodiments, as long as the nozzle surface 50 may be heated, and the heater may be positioned any place on the side of the recording head. In addition, the piezoelectric element may operate to generate heat so as to be used as a heater.

The invention is not intended to be limited to the above mentioned embodiments. For example, in the above-described embodiments, the wiping unit is configured so as to move upward and downward, however the recording head may be configured so as to move upward and downward. In addition, in the above-described embodiments, the UV ink to be cured by irradiation with ultraviolet rays is ejected from the nozzle; however any photo-curable liquid to be cured by irradiation with light may be ejected. Furthermore, in the above-described embodiments, an ink jet recording head mounted on an ink jet printer has been illustrated; however, the invention is also applicable to other liquid ejecting heads for ejecting a photo-curable liquid.

The entire disclosure of Japanese Patent Application No. 2012-232579, filed Oct. 22, 2012 is expressly incorporated by reference herein.

What is claimed is:

1. A liquid ejecting apparatus, comprising:
a liquid ejecting head which is capable of ejecting a photo-curable liquid to be cured by irradiation with light from nozzles which open at a nozzle surface of a nozzle-forming member;
a wiping unit for wiping the nozzle surface with a wiping member in contact with the nozzle surface, a portion of the wiping member in contact with the nozzle surface being made of cloth; and
a heating mechanism for generating heat to heat the nozzle surface;
wherein the wiping member is capable of wiping the nozzle surface in a state in which the nozzle surface is being heated by the heating mechanism.

2. The liquid ejecting apparatus according to claim 1,
wherein the heating mechanism is provided in the wiping unit, and
wherein the heating mechanism is capable of heating the wiping member.

3. The liquid ejecting apparatus according to claim 2,
wherein the wiping unit includes an impregnation liquid reserving section for storing an impregnation liquid with which the wiping member is impregnated,
wherein the heating mechanism is provided in the impregnation liquid reservoir, and
wherein the heating mechanism is capable of heating the impregnation liquid.

4. The liquid ejecting apparatus according to claim 1,
wherein the heating mechanism is provided in the liquid ejecting head, and
wherein the heating mechanism is capable of heating the nozzle-forming member.

5. The liquid ejecting apparatus according to claim 1,
wherein the nozzle surface has a concave region including a region having the nozzles formed thereon and a convex region protruding toward the wiping unit from the concave region,
wherein the wiping member is capable of being brought into contact with both the concave region and the convex region and has a region opposing the concave region recessed away from the nozzle surface with respect to a region opposing the convex region.
